(19) United States
(12) Patent Application Publication
(10) Pub. No.: US 2012/0066414 A1
(43) Pub. Date: Mar. 15, 2012

(54) NETWORK STORAGE SYSTEM AND NETWORK STORAGE METHOD

(76) Inventors: Shu-Kai Ho, Hsinchu City (TW); Shih-Jen Lu, Taipei County (TW)

(21) Appl. No.: 12/961,507

(22) Filed: Dec. 7, 2010

(30) Foreign Application Priority Data
Sep. 15, 2010 (TW) 099131212

(51) Int. Cl. G06F 13/28; G06F 5/00

(52) U.S. Cl. 710/22; 710/52

(57) ABSTRACT

The present invention provides a network storage system for increasing data writing efficiency of a net storage service and a network storage method for increasing data writing efficiency of the net storage service. The network storage system comprises: a first module, a first data buffer, a second module, and a third module. The present invention can omit the standard process of the traditional operation system processing files when writing data, and the network storage system and the network storage method of the present invention can use a new file processing procedure in the second module and the third module. In this way, the present invention can shorten the file processing flow in the traditional network storage system, so as to increase data writing efficiency of the net storage service over 50%.

### BACKGROUND OF THE INVENTION

1. Field of the Invention

The present invention relates to a method for providing a network storage architecture, and more particularly, to a network storage system for increasing data writing efficiency of a net storage service and a network storage method for increasing data writing efficiency of the net storage service.

2. Description of the Prior Art

A network-attached storage (NAS) server is a storage device that is connected via the Internet and is dedicated to provide file access for computer systems by means of file-sharing network protocols such as SAMBA. The NAS server is capable of easily providing a network data-sharing mechanism with unlimited capacity expansion by means of a distributed architecture. Computer systems with a variety of operating systems can enjoy convenient file access services through the NAS server as long as they are connected to any node of the Internet. Hence, the data access speed of the NAS server has become an important topic of this field.

In general, a data length of an Ethernet packet is typically 1.5K bytes, wherein useful information may occupy a data length of 1-1460 bytes. A hard disk uses “a sector” as its data length unit. In other words, as for the NAS server, the data format of the data received from a network-base is different from the data format of the data being written into the hard disk. Hence, in accordance with the prior art, the received data is reorganized by the operating system of the NAS server so as to perform a data format conversion. As an illustration, please refer to FIG. 1. FIG. 1 shows a simplified block diagram of a conventional network storage system 100 in accordance with the prior art. As shown in FIG. 1, the conventional network storage system 100 comprises: a first data buffer 110, a second data buffer 120, a third data buffer 130, and an operation system (OS) file processing module 140. The first data buffer 110 is utilized for storing a storage data received from a network-base, wherein the storage data includes a plurality of frames with a size of 1.5K bytes (e.g., DS1, DS2, . . . ). The second data buffer 120 comprises a plurality of memory pages, such as Page0˜Page14, wherein the plurality of memory pages are utilized for storing the storage data which is about to be written into a storage device 170 (such as a hard disk). When a user wants to write the storage data into the hard disk 170, the storage data (e.g., DS1, DS2, . . . ) is firstly stored into the first data buffer 110 in the kernel level of the operation system via a first network-base 150 from a network terminal 160. After that, the network storage system 100 employs a processor (such as a central processing unit (CPU), not shown) to copy the storage data to the third data buffer 130 in the application level of the operation system, and then the third data buffer 130 temporarily stores the storage data. Until the collection of the storage data is completed, the storage data will be reorganized by the network storage system 100. Afterwards, the processor copies the reorganized data to the plurality of memory pages page0˜page14 of the second data buffer 120 in the kernel level of the operating system. Next, the network storage system 100 transmits the storage data stored in the memory pages page0˜page14 of the second data buffer 120 to the OS file processing module 140 for processing, and write into the storage device 170 via a second network-base 180. However, the standard process of the OS file processing module 140 processing files costs a lot of time, and thus the data writing efficiency of the net storage service is very low when using the conventional network storage system and the conventional network storage method. For example, the data writing efficiency of the net storage service is only 13 MB/s.

### SUMMARY OF THE INVENTION

It is therefore one of the objectives of the present invention to provide a network storage system for increasing data writing efficiency of a net storage service and a network storage method for increasing data writing efficiency of the net storage service, so as to solve the above problem.

In accordance with an embodiment of the present invention, a network storage system is disclosed, and the network storage system can be utilized for increasing data writing efficiency of a net storage service. The network storage system comprises: a first module, a first data buffer, a second module, and a third module. The first module is utilized for detecting whether a storage data writing event occurs at a network-base. The first data buffer is coupled to the network-base, and is utilized for storing a storage data which is received via the network-base and about to be written into a storage device. The second module is coupled to the storage device, and is utilized for transforming a first data format of the storage data to a second data format which is compatible with the storage device, and writing the storage data into the storage device. The third module is coupled to the first module, the first data buffer, and the second module, wherein the third module comprises a second data buffer, which is utilized for storing the storage data which is about to be written into the storage device. When the first module detects that the storage data writing event occurs, the first module notifies the third module to control the first data buffer to write the stored storage data of the first data buffer into the second data buffer, and the third module directly transmits the storage data written in the second data buffer to the second module, and the second module transforms the first data format of the storage data received from the third module to the second data format which is compatible with the storage device, and directly writes the storage data into the storage device.

In accordance with an embodiment of the present invention, a network storage method is disclosed, and the network storage method can be utilized for increasing data writing efficiency of a net storage service. The network storage method comprises: providing a first module, a first data buffer, a second module, and a third module, wherein the first data buffer is utilized for storing a storage data which is received via a network-base and about to be written into a storage device, and the third module comprises a second data buffer; utilizing the first module to detect whether a storage data writing event occurs at a network-base; when the first module detects that the storage data writing event occurs, utilizing the first module to notify the third module to control the first data buffer to write the stored storage data of the first data buffer into the second data buffer; utilizing the third module to directly transmit the storage data written in the second data buffer to the second module; and utilizing the second module to transform the first data format of the storage data received from the third module to the second data format which is compatible with the storage device, and directly write the storage data into the storage device.

Briefly summarized, the network storage system for increasing data writing efficiency of a net storage service and the network storage method for increasing data writing efficiency of the net storage service disclosed by the present invention can omit the standard process of the traditional operation system processing files when writing data, and the network storage system and use the modules provided by the present invention to perform file storing functions, and the network storage method of the present invention can use a new file processing procedure in the second module and the third module. In this way, the present invention can shorten the file processing flow in the traditional network storage system, so as to increase data writing efficiency of the net storage service over 50%. For example, if using the conventional network storage system and the conventional network storage method, the data writing efficiency of the net storage service is only 13 MB/s; however, if using the network storage system and the network storage method disclosed by the present invention, the data writing efficiency of the net storage service can be increased to 20 MB/s obviously.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional network storage system 100 in accordance with the prior art.

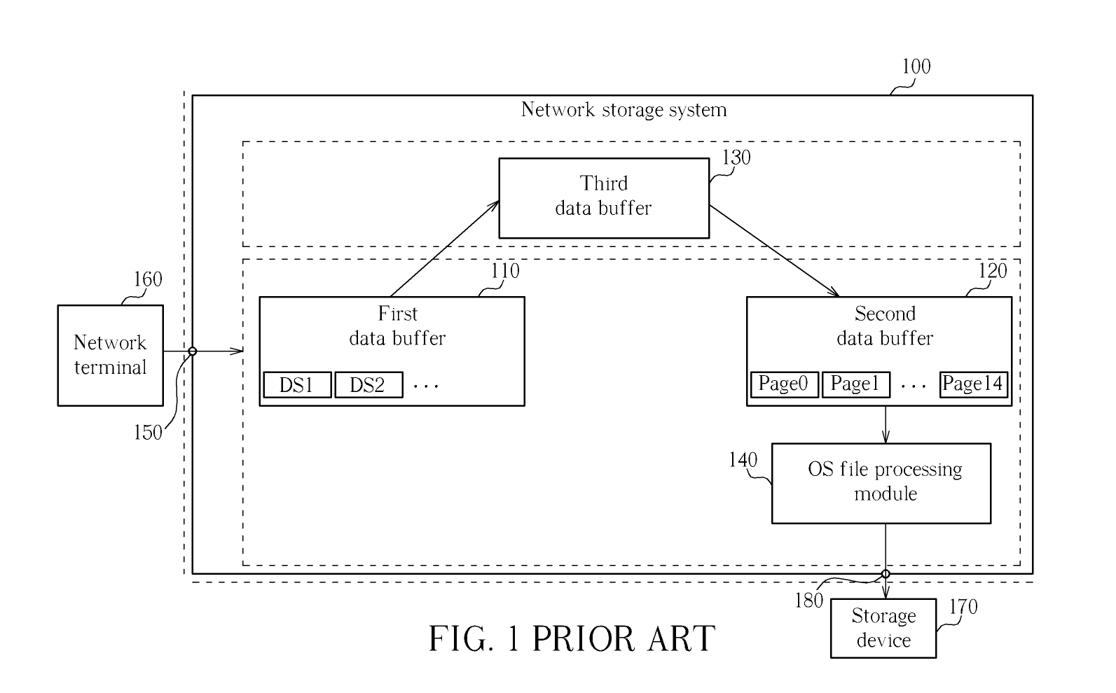

FIG. 2 shows a simplified block diagram of a network storage system 200 for increasing data writing efficiency of a net storage service in accordance with a first embodiment of the present invention

FIG. 3 is a flowchart showing a network storage method for increasing data writing efficiency of the net storage service in accordance with the above operation schemes of the network storage system 200 in an embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

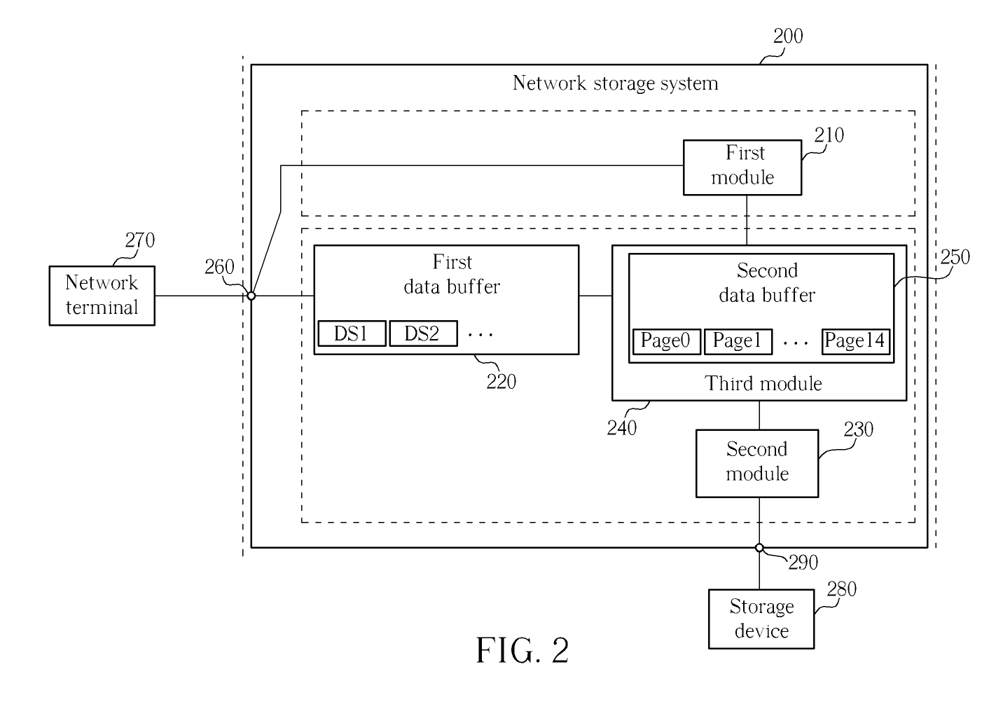

Please refer to FIG. 2. FIG. 2 shows a simplified block diagram of a network storage system 200 for increasing data writing efficiency of a net storage service in accordance with a first embodiment of the present invention, wherein the net storage service is an application program with net storage functions and the network storage system 200 can be a network-attached storage (NAS), such as a SAMBA server. As shown in FIG. 2, the network storage system 200 comprises: a first module 210, a first data buffer 220, a second module 230, and a third module 240, wherein the third module 240 comprises a second data buffer 250, and the first module 210 operates in an application level of an operation system (OS) of the network storage system 200, and the first data buffer 220, the second data buffer 250, the second module 230, and the third module 240 operates in a kernel level of the OS of the network storage system 200.

The first module 210 is utilized for detecting whether a storage data writing event occurs at a first network-base 260, wherein the network storage system 200 is conncected to a network terminal 270 via the first network-base 260 (the network terminal 270 can be various electronic devices such as a personal computer or a notebook computer). In other words, the first module 210 is utilized for detecting whether the network terminal 270 has an operation of writing the storage data into the network storage system 200 via the first network-base 260. The first data buffer 220 is coupled to the first network-base 260, and is utilized for storing a storage data which is received via the first network-base 260 and about to be written into a storage device 280. For example, the storage data can comprise a plurality of frames with a size of 1.5K bytes (e.g., DS1, DS2, . . . ). The second data buffer 250 is utilized for storing the storage data which is about to be written into the storage device 280, wherein the storage device 280 is connected to the network storage system 200 via a second network-base 290, and the storage device 280 can be a hard disk.

The second module 230 is coupled to the storage device 280, and is utilized for transforming a first data format of the storage data to a second data format which is compatible with the storage device 280. The third module 240 is coupled to the first module 210, the first data buffer 220, and the second module 230. When the first module 210 detects that the storage data writing event occurs, the first module 210 notifies the third module 240 to control the first data buffer 220 to write the stored storage data of the first data buffer 220 into the second data buffer 250. For example, the second data buffer 250 can comprise a plurality of data buffering units PAGE0˜PAGE14, and each of the plurality of data buffering units PAGE0˜PAGE14 is a memory page. The first module 210 notifies the third module 240 to control the first data buffer 220 to write the stored storage data of the first data buffer 220 into the plurality of data buffering units PAGE0˜PAGE14 of the second data buffer 250 in the third module 240. In addtion, the first data buffer 220 also can directly write the stored storage data of the first data buffer 220 into the plurality of data buffering units PAGE0˜PAGE14 of the second data buffer 250 by means of direct memory access (DMA). The third module 240 directly transmits the storage data written in the second data buffer 250 to the second module 230, and the second module 230 transforms the first data format of the storage data received from the third module 240 to the second data format which is compatible with the storage device 280, and directly writes the storage data into the storage device 280. In addition, please note that the above embodiment is only for an illustrative purpose and is not meant to be a limitation of the present invention.

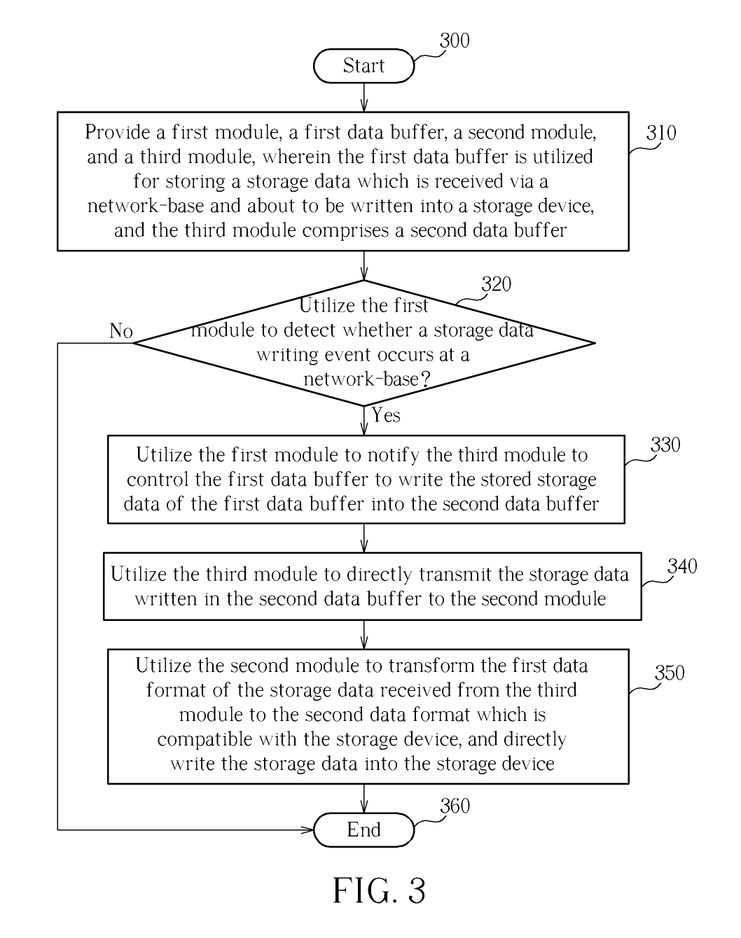

Please refer to FIG. 3. FIG. 3 is a flowchart showing a network storage method for increasing data writing efficiency of the net storage service in accordance with the above operation schemes of the network storage system 200 in an embodiment of the present invention. Provided that substantially the same result is achieved, the steps of the process flowchart need not be in the exact order shown and need not be contiguous, that is, other steps can be intermediate. In addtion, please note that the network storage method of the present invention can be realized by a software. In other words, the network storage method disclosed by the present invention can be a software applied to network-attached storage (NAS). The network storage method of the present invention comprises the following steps:

Step 300: Start.

Step 310: Provide a first module, a first data buffer, a second module, and a third module, wherein the first data buffer is utilized for storing a storage data which is received via a network-base and about to be written into a storage device, and the third module comprises a second data buffer.

Step 320: Utilize the first module to detect whether a storage data writing event occurs at a network-base?

Step 330: Utilize the first module to notify the third module to control the first data buffer to write the stored storage data of the first data buffer into the second data buffer.

Step 340: Utilize the third module to directly transmit the storage data written in the second data buffer to the second module.

Step 350: Utilize the second module to transform the first data format of the storage data received from the third module to the second data format which is compatible with the storage device, and directly write the storage data into the storage device.

Step 360: End.

Briefly summarized, the network storage system for increasing data writing efficiency of a net storage service and the network storage method for increasing data writing efficiency of the net storage service disclosed by the present invention can omit the standard process of the traditional operation system processing files when writing data, and the network storage system and use the modules provided by the present invention to perform file storing functions, and the network storage method of the present invention can use a new file processing procedure in the second module and the third module. In this way, the present invention can shorten the file processing flow in the traditional network storage system, so as to increase data writing efficiency of the net storage service over 50%. For example, if using the conventional network storage system and the conventional network storage method, the data writing efficiency of the net storage service is only 13 MB/s; however, if using the network storage system and the network storage method disclosed by the present invention, the data writing efficiency of the net storage service can be increased to 20 MB/s obviously.

Those skilled in the art will readily observe that numerous modifications and alterations of the device and method may be made while retaining the teachings of the invention.

What is claimed is:

1. A network storage system, comprising:
a first module, for detecting whether a storage data writing event occurs at a network-base;
a first data buffer, coupled to the network-base, for storing a storage data which is received via the network-base and about to be written into a storage device;
a second module, coupled to the storage device, for transforming a first data format of the storage data to a second data format which is compatible with the storage device, and writing the storage data into the storage device; and
a third module, coupled to the first module, the first data buffer, and the second module, wherein the third module comprises: a second data buffer, for storing the storage data which is about to be written into the storage device; when the first module detects that the storage data writing event occurs, the first module notifies the third module to control the first data buffer to write the stored storage data of the first data buffer into the second data buffer, and the third module directly transmits the storage data written in the second data buffer to the second module, and the second module transforms the first data format of the storage data received from the third module to the second data format which is compatible with the storage device, and directly writes the storage data into the storage device.

2. The network storage system of claim 1, wherein the second data buffer comprises a plurality of data buffering units, and the first module notifies the third module to control the first data buffer to write the stored storage data of the first data buffer into the plurality of data buffering units.

3. The network storage system of claim 2, wherein each of the plurality of data buffering units is a memory page.

4. The network storage system of claim 2, wherein the first data buffer directly writes the stored storage data of the first data buffer into the plurality of data buffering units by means of direct memory access (DMA).

5. The network storage system of claim 1, wherein the first module operates in an application level of an operation system (OS) of the network storage system, and the first data buffer, the second data buffer, the second module, and the third module operates in a kernel level of the OS of the network storage system.

6. The network storage system of claim 1, being a SAMBA server.

7. The network storage system of claim 1, wherein the storage device is a hard disk.

8. A network storage method, comprising:
providing a first module, a first data buffer, a second module, and a third module, wherein the first data buffer is utilized for storing a storage data which is received via a network-base and about to be written into a storage device, and the third module comprises a second data buffer;
utilizing the first module to detect whether a storage data writing event occurs at a network-base;
when the first module detects that the storage data writing event occurs, utilizing the first module to notify the third module to control the first data buffer to write the stored storage data of the first data buffer into the second data buffer;
utilizing the third module to directly transmit the storage data written in the second data buffer to the second module; and
utilizing the second module to transform the first data format of the storage data received from the third module to the second data format which is compatible with the storage device, and directly write the storage data into the storage device.

9. The network storage method of claim 8, wherein the second data buffer comprises a plurality of data buffering units, and the first module notifies the third module to control the first data buffer to write the stored storage data of the first data buffer into the plurality of data buffering units.

10. The network storage method of claim 9, wherein each of the plurality of data buffering units is a memory page.

11. The network storage method of claim 9, wherein the first data buffer directly writes the stored storage data of the first data buffer into the plurality of data buffering units by means of direct memory access (DMA).

12. The network storage method of claim 8, wherein the first module operates in an application level of an operation system (OS) of the network storage system, and the first data buffer, the second data buffer, the second module, and the third module operates in a kernel level of the OS of the network storage system.

13. The network storage method of claim 8, being a SAMBA server.

14. The network storage method of claim 8, wherein the storage device is a hard disk.
